(19) United States
(12) Patent Application Publication
(10) Pub. No.: US 2025/0173846 A1
(43) Pub. Date: May 29, 2025

(54) PERCEPTUAL LOCAL CONTRAST AND DETAIL ENHANCEMENT

(71) Applicant: Samsung Electronics Co., Ltd., Suwon-si (KR)

(72) Inventors: Joonsoo Kim, Irvine, CA (US); Kamal Jnawali, Tustin, CA (US); Chenguang Liu, Tustin, CA (US)

(21) Appl. No.: 18/631,938

(22) Filed: Apr. 10, 2024

Related U.S. Application Data
(60) Provisional application No. 63/603,018, filed on Nov. 27, 2023.

(51) Int. Cl. G06T 5/94; G09G 3/3208

(52) U.S. Cl. CPC G06T 5/94; G09G 3/3208; G06T 2207/20192; G09G 2320/0257; G09G 2320/046; G09G 2320/066

(57) ABSTRACT

One embodiment provides a computer-implemented method that includes applying, by a computing device, a local contrast enhancement algorithm to an original image. A local contrast enhanced image is generated based on adjusting a first parameter and a second parameter during the local contrast enhancement algorithm applied to the original image. The computing device controls an increase of an amount of brightness for the local contrast enhanced image based on adjusting at least the first parameter during the local contrast enhancement algorithm.

### CROSS-REFERENCE TO RELATED APPLICATIONS

This application claims the priority benefit of U.S. Provisional Patent Application Ser. No. 63/603,018, filed on Nov. 27, 2023, which is incorporated herein by reference in its entirety.

### COPYRIGHT DISCLAIMER

A portion of the disclosure of this patent document may contain material that is subject to copyright protection. The copyright owner has no objection to the facsimile reproduction by anyone of the patent document or the patent disclosure as it appears in the patent and trademark office patent file or records, but otherwise reserves all copyright rights whatsoever.

### TECHNICAL FIELD

One or more embodiments relate generally to display imaging enhancement, and in particular, to providing display imaging perceptual local contrast and detail enhancement.

### BACKGROUND

Recently, organic light emitting diode (OLED) displays have been widely used in many multimedia devices such as televisions and smart phones because they can show better image contrast and have lower power consumption than a liquid crystal display (LCD). However, the OLED display has a major problem: OLED burn-in, which refers to a non-uniform deterioration pixel region and looks like ghosting.

### SUMMARY

One embodiment provides a computer-implemented method that includes applying, by a computing device, a local contrast enhancement algorithm to an original image. A local contrast enhanced image is generated based on adjusting a first parameter and a second parameter during the local contrast enhancement algorithm applied to the original image. The computing device controls an increase of an amount of brightness for the local contrast enhanced image based on adjusting at least the first parameter during the local contrast enhancement algorithm.

Another embodiment includes a non-transitory processor-readable medium that includes a program that when executed by a processor provides perceptual local contrast and detail enhancement including applying, by the processor, a local contrast enhancement algorithm to an original image. A local contrast enhanced image is generated based on adjusting a first parameter and a second parameter during the local contrast enhancement algorithm applied to the original image. The processor controls an increase of an amount of brightness for the local contrast enhanced image based on adjusting at least the first parameter during the local contrast enhancement algorithm.

Still another embodiment provides an apparatus that includes a memory storing instructions, and at least one processor executes the instructions including a process configured to apply a local contrast enhancement algorithm to an original image. A local contrast enhanced image is generated based on adjusting a first parameter and a second parameter based on adjusting a first parameter and a second parameter during the local contrast enhancement algorithm applied to the original image. The process further controls an increase of an amount of brightness for the local contrast enhanced image based on adjusting at least the first parameter during the local contrast enhancement algorithm.

These and other features, aspects and advantages of the one or more embodiments will become understood with reference to the following description, appended claims and accompanying figures.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 illustrates a block diagram for detail restoration and sharpening, according to some embodiments;

FIGS. 2A-D illustrate examples of target luminance buffer (TLB) visualization, according to some embodiments;

FIG. 3 illustrates a block diagram of a system for display imaging perceptual local contrast and detail enhancement, according to some embodiments;

FIG. 4 illustrates a block diagram for luminance reduction processing, according to some embodiments; and

FIG. 5 illustrates a process for providing display imaging perceptual local contrast and detail enhancement, according to some embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

A description of example embodiments is provided on the following pages. The text and figures are provided solely as examples to aid the reader in understanding the disclosed technology. They are not intended and are not to be construed as limiting the scope of this disclosed technology in any manner. Although certain embodiments and examples have been provided, it will be apparent to those skilled in the art based on the disclosures herein that changes in the embodiments and examples shown may be made without departing from the scope of this disclosed technology.

Some embodiments relate generally to display imaging enhancement, and in particular to providing display imaging perceptual local contrast and detail enhancement. One embodiment provides a computer-implemented method that includes applying, by a computing device, a local contrast enhancement algorithm to an original image. A local contrast enhanced image is generated based on adjusting a first parameter and a second parameter during the local contrast enhancement algorithm applied to the original image. The computing device controls an increase of an amount of brightness for the local contrast enhanced image based on adjusting at least the first parameter during the local contrast enhancement algorithm.

To prevent OLED burn-in, the disclosed technology can provide luminance reduction on one or more stationary pixel regions. Reducing luminance on large stationary regions, however, causes another image quality degradation such as reduced perceptual local image contrast and sharpness or loss of details. If the luminance on the region is increased, however, it would cause increased burn-in. As such, an approach that enhances the image local contrast and sharpness while not causing more burn-in would be advantageous.

Luminance reduced region(s) sometimes causes noticeable degradation such as less image contrast and details. For example, degradation may include a decrease of perceptual local contrast when the luminance of the local region is reduced. The human visual system is sensitive to the image luminance. If the luminance of a stationary region is reduced, a human can easily feel/perceive the region to be darker and the perceptual contrast of the region would be lower. Some luminance reduction approaches apply the same reduction rate on the stationary region, which causes decrease of perceptual contrast.

Another example of degradation includes less edge sharpness or fine detail loss when the luminance of the local region is reduced. Reducing luminance can reduce the sharpness on the edge region or suppress the strength of fine details. For example, when the luminance reduction is applied, the magnitude of textures also becomes smaller. If larger reduction occurs, the fine details of the texture can be lost. To resolve this issue, in one or more embodiments the disclosed technology can include an approach to keep or restore the sharp edges and fine details even after large luminance reduction is applied.

Still another example of degradation includes balance between local contrast enhancement with sharpness and Burn-in protection. Generally, people can perceive a bright image better than a darker image. However, if the luminance on the region is increased for a better image contrast, it will cause more burn-in. Therefore, in some embodiments the disclosed technology can provide an approach and/or algorithm that keeps the similar or same burn-in possibility, but it enhances the image contrast and sharpness better.

In some embodiments, the disclosed technology can include (i.e., but is not limited to): providing a balance between local contrast enhancement with sharpening and burn-in protection. To enhance the local image contrast, the brightness difference of pixels in a local region can be increased. To do this generally, the brightness of some region is increased while the brightness of the neighboring region is decreased. However, the increase of the brightness would cause more burn-in, which is contradictory to the purpose of luminance reduction module or processing unit. In one or more embodiments, the disclosed technology can provide a local image contrast algorithm to control the increase of brightness to achieve same or similar burn-in protection while enhancing the local image contrast.

In one or more embodiments, the disclosed technology provides extracting details before luminance reduction processing and adding it back to the luminance reduced image in the luminance reduction module or processing unit of an OLED burn-in protection system. Reducing the luminance on the stationary region would suppress the fine details on the region. To keep the fine details even after luminance reduction, in some embodiments the disclosed technology can extract the details before luminance reduction and add it back to the luminance reduction image.

In some embodiments, the disclosed technology provides reutilizing a target luminance buffer (TLB) to achieve both luminance reduction and local image contrast enhancement in the luminance reduction module or processing unit of the OLED burn-in protection system. In one or more embodiments, in accordance with the luminance reduction of the disclosed technology, the TLB can be used to control the luminance reduction rate on the stationary region. In one or more embodiments, the disclosed technology can modify this TLB to achieve not only luminance reduction but also local image contrast enhancement. Since the disclosed technology can re-utilize the TLB to enhance local image contrast, in some embodiments there may not be a need for extra hardware (and the associated cost) to improve local image contrast.

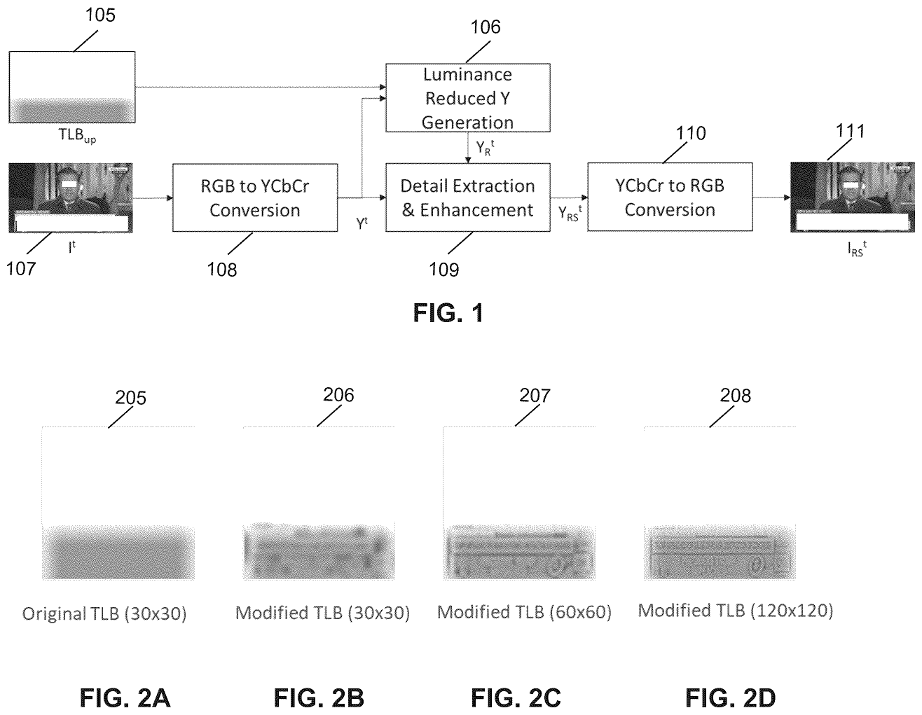

FIG. 1 illustrates a block diagram for detail restoration and sharpening, according to some embodiments. In one or more embodiments, the detail restoration and sharpening processing includes inputs of an updated gray scaled image in a TLB 105 and an image at time t 107. The updated gray scaled image in the TLB 105 is provided to the luminance reduced Y generation 106 processing. The image at time t (F)107 is provided to red, green, blue (RGB) color values to the YCbCr (luma (Y)), chroma (Cb) and chroma (Cr)) color space conversion 108 processing. The result of the YCbCr color space conversion 108 processing, Y^{t}, is provided to the luminance reduced Y generation 106 processing. The result of the luminance reduced Y generation 106 processing, Y_{R}^{t}, along with Y^{t} are provided to the detail extraction and enhancement 109 processing. The result of the detail extraction and enhancement 109 processing, Y_{RS}^{t}, is provided to the YCbCr to RGB conversion 110 processing, which results in an image, I_{RS}^{t}, 111.

To enhance the local contrast enhancement, in some embodiments the disclosed technology can adopt “unsharp masking” in a small resolution image. Distinguishable from conventional “unsharp masking,” the disclosed technology can control the positive detailed image (R+) and negative detailed image (R−) separately. By assigning a small weight or zero weight to R+ while assigning a larger weight to R−, the disclosed technology can achieve the burn-in protection as well as local contrast enhancement. This part of the local contrast enhancement algorithm is described below.

In some embodiments, an example local contrast enhancement algorithm or processing includes the following. In one or more embodiments, the algorithm or processing generates luminance reduced gray scale downsampled image (I_{d-R}) from downsampled gray image (I_{d}) as

$${I}_{d - R} = {( {I}_{d}^{2.2} \cdot TLB )}^{\frac{1}{2.2}} .$$

The local contrast enhanced image (I_{d-R-LC}) is generated by adjusting α₁ and α₂ as follows:

$$( {I}_{d - R - LC} ) = {I}_{d - R} + {α}_{1} {R}_{+} + {α}_{2} {R}_{-}$$

$$R = ( δ - {H}_{G} ) * {I}_{d - R}$$

H_{G}: 5×5 Gaussian filter
R₊=R where R≥0
R₋=R where R<0.

By adjusting α₁, the processing can control the amount of luminance increase for local contrast enhancement, which provides for controlling the degree of burn-in. For making the same burn-in potential with the local contrast enhancement algorithm or processing, α₁ is set to 0 (α₁=0). In a working or real case, α₁ is set to a small value (e.g., α₁=0.125) even though it may cause a little bit more of burn-in because this setting generates more of a natural local enhancement effect.

In one or more embodiments, the local contrast enhancement algorithm or processing generates a local contrast enhanced image with a mask (I_{d-R-LC-m}). Since the local contrast is needed to be enhanced only in a luminance reduced region, the processing generates the mask (M_{d}) using the TLB and blends I_{d-R-LC} with the original luminance reduced image (I_{d-R}) using the mask as follows:

$${I}_{d - R - LC - m} = {I}_{d - R} \cdot ( 1 - {M}_{d} ) + {I}_{d - R - LC} \cdot {M}_{d}$$

M_{d}: 30×30 Logo Mask

$${M}_{d} = clip ( ( 1 - TLB ) * {s}_{mask} , 0 , 1 )$$

where M_{d} is generated using the TLB.

In some embodiments, the TLB is updated as follows.

$${TLB}_{updated} = clip ( \frac{{I}_{d - R - LC - m}^{2.2}}{{I}_{d}^{2.2}} , TLB * {W}_{low} , TLB * {W}_{high}$$

W_{low} and W_{high} are lower and upper bounds for the updated TLB.

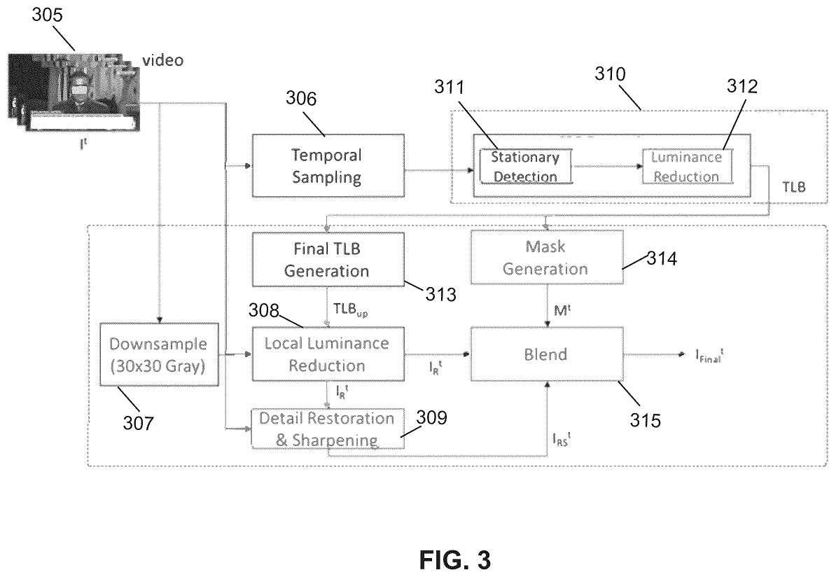

In one or more embodiments, in the detail restoration and sharpening 309 processing (FIG. 3) the processing extracts the detail image (R) from an original frame (gray image, Y) first and adds it back to the luminance reduced image (Y_{R}). By doing this, the processing keeps all the details from the original frame because the details are extracted before suppressing them through luminance reduction. Additionally, the processing uses “unsharp masking,” which is a technique to control the degree of details or the degree of edge sharpening that also helps to control the balancing between edge enhancement and burn-in protection.

FIGS. 2A-D illustrate examples of TLB visualization, according to some embodiments. In one or more embodiments, the TLB is utilized as a weight map in the luminance reduction system, and the local contrast enhancement of the disclosed technology also utilizes the TLB to enhance the local image contrast. In other words, the disclosed technology achieves both luminance reduction and local image contrast enhancement by modifying the TLB. Because of this, the disclosed technology does not need extra hardware (with additional hardware cost) to enhance local image contrast. FIGS. 2A-D shows how the disclosed technology can achieve the local image contrast by modifying the existing TLB. Instead of applying the same reduction rate on the stationary region, some embodiments apply different reduction rates depending on the image content there, which can enhance the local image contrast. FIG. 2A shows the original TLB visualization for a 30×30 sized TLB 205. FIG. 2B shows a modified TLB visualization for a 30×30 sized TLB 206. FIG. 2C shows a modified TLB visualization for a 60×60 sized TLB 207. FIG. 2D shows a modified TLB visualization for a 120×120 sized TLB 208. Note that a TLB sized as 30×30 is quite small, but the disclosed technology can achieve a better image contrast when the TLB size is increased.

FIG. 3 illustrates a block diagram of a system for display imaging perceptual local contrast and detail enhancement, according to some embodiments. In one or more embodiments, the video image 305 (It) is provided to temporal sampling 306 and downsample 307 (30×30 gray). The result of temporal sampling processing 306 is provided to block 310 that includes stationary detection 311 processing and luminance reduction 312 (module or processing unit) processing. The result from the luminance reduction 312 processing is provided to final TLB generation 313 processing and mask generation 314 processing. The updated TLB (TLB_{UP}) and the result from the downsample 307 processing are provided to the local luminance reduction 308 processing. The result from the local luminance reduction 308 processing (I_{R}^{t}) is provided to the detail restoration and sharpening 309 processing. The result of the detail restoration and sharpening 309 processing (I_{RS}^{t}), the result from the local luminance reduction 308 processing (I_{R}^{t}) and the result of the mask generation 314 processing (M^{t}) are provided to the blend 315 processing, which results in the final image (I_{Final}^{t}).

In some embodiments, it is advantageous to enhance the local contrast and details on the luminance-reduced region (of the video images 305) so that the image degradation caused by the luminance reduction 312 processing is not noticeable to users. The disclosed technology provides a local contrast and detail enhancement processing unit or module that 1) enhances the local contrast and details in only the luminance-reduced regions and 2) causes the least impact on potential burn-in. The disclosed technology can enhance the quality of the luminance reduced image of the system. In some embodiments, the disclosed technology can be built on or can modify existing systems.

For one or more embodiments, the luminance reduction 312 processing is modified to enhance local contrast of the luminance reduced image, and the detail restoration and sharpening 309 processing, the mask generation 314 processing and the blend 315 processing are added in a system on a chip (SOC) side to improve the details and sharpness of edges on the luminance reduced regions. The downsample 307 processing and the local luminance reduction 308 processing are additionally added or modified for further local contrast enhancement. Note that in some embodiments the downsample 307 processing and the local luminance reduction 308 processing are added because the current TLB size is too small to improve local contrast (e.g., only 30×30). In other words, if the size of the TLB is increased, the downsample 307 processing and the local luminance reduction 308 processing are not necessary to be added, which can reduce the hardware and associated costs.

In some existing systems, the coordinates of bounding boxes, which include stationary regions, are generated from a dynamic logo list operation block. Then, the TLB, which includes the reduction rate of the entire region on the current frame, is generated in the TLB generation block (the TLB can be considered as a weight map of how much is needed to reduce the luminance of an input frame). Note that one reduction rate is computed in each bounding box, so the same reduction rate is applied to the entire region of the one bounding box (before smoothing). Because the same reduction rate is applied to all the pixels in one bounding box regardless of image content inside it, the perceptual image contrast would be reduced when the luminance reduction is applied.

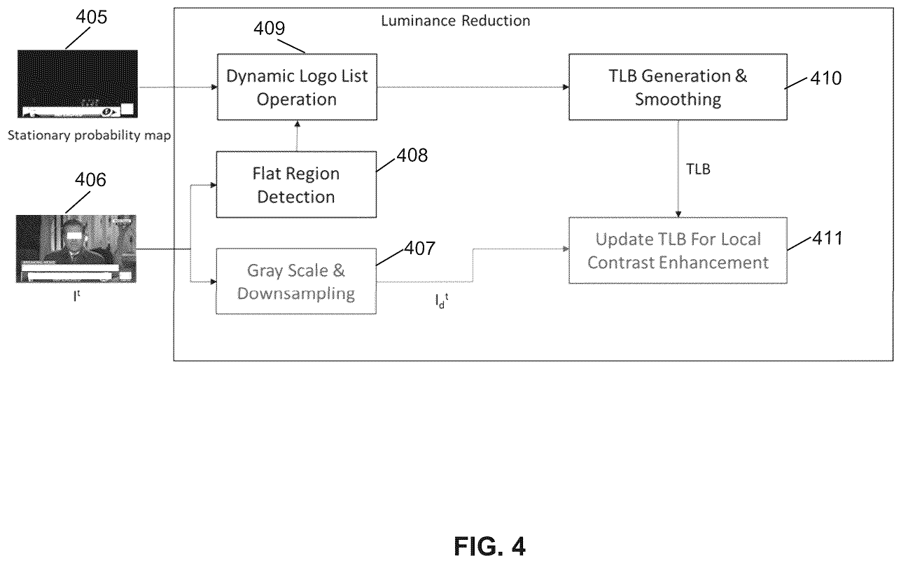

FIG. 4 illustrates a block diagram for modified luminance reduction processing, according to some embodiments. In one or more embodiments, enhancing local contrast enhancement processing can include further modifying the TLB so that the TLB can be used not only as a reduction weight map but also local contrast enhancement gain map. In some embodiments, the modified TLB includes some logo imaging appearance while an original TLB does not. Note that the size of the TLB can be very small such as 30×30. Therefore, the effect of local contrast enhancement with this small TLB is very limited. If the size of TLB is increased, one or more embodiments can include more detailed image content in the TLB, and the disclosed technology can achieve better local image contrast utilizing the modified luminance reduction processing.

In some embodiments, the stationary probability map 405 is provided to the dynamic logo list operation 409 processing, and the image 406 (It) is input to a flat region detection 408 processing and gray scale and downsampling 407 processing. The result of the flat region detection 408 processing is provided to the dynamic logo list operation 409 processing. The result of the dynamic logo list operation 409 processing is provided to the TLB generation and smoothing 410 processing. The result (TLB) of the TLB generation and smoothing 410 processing and the result (I_{d}^{t}) of the gray scale and downsampling 407 processing are provided to the update TLB for local contrast enhancement 411 processing.

In one or more embodiments, to enhance the local image contrast the disclosed technology adopts the “Unsharp Mask” process on a downsampled gray image. To do this, the disclosed technology first converts an RGB image (the image 406 (I^{t})) into grayscale first and downsample it to 30×30 by way of the gray scale and downsampling 407 processing. Using this 30×30 gray image with the TLB, the disclosed technology updates the TLB (by way of the update TLB for local contrast enhancement 411 processing) so that the TLB can represent local contrast enhancement as well as luminance reduction.

In some embodiments, the modified luminance reduction processing updates the TLB for local contrast enhancement using the update TLB for local contrast enhancement 411 processing as follows. The update TLB for local contrast enhancement 411 processing generates a luminance reduced gray scale downsampled image (I_{d-R}) from the downsampled gray image (I_{d}) from the gray scale and downsampling 407 processing as follows.

$${I}_{d - R} = {( {I}_{d}^{2.2} \cdot TLB )}^{\frac{1}{2.2}}$$

The update TLB for local contrast enhancement 411 processing proceeds to generate a local contrast enhanced image (I_{d-R-LC}) by adjusting α₁ and α₂ as follows.

$${I}_{d - R - LC} = {I}_{d - R} + {α}_{1} {R}_{+} + {α}_{2} {R}_{-}$$

$$R = ( δ - {H}_{G} ) * {I}_{d - R}$$

H_{G}: 5×5 Gaussian filter
R₊=R where R≥0
R₋=R where R<0.
By adjusting α₁, the system can control the amount of luminance increase for local contrast enhancement, which allows the system to control the degree of burn-in. If it is desired to make the exact same burn-in potential with the update TLB for local contrast enhancement 411 processing, the disclosed technology sets α₁=0. In some cases (e.g., a real-world example scenario), a small value is set such as α₁=0.125, even though it may cause a little bit more burn-in because this setting generates a more natural local enhancement effect.

Continuing, the local contrast enhanced image is generated with a mask (l_{d-R-LC-m}). Since the system needs to enhance the local contrast in only a luminance reduced region, the disclosed technology generates the mask (M_{d}) using the TLB and blends I_{d-R-LC} with the original luminance reduced image (I_{d_R}) using the mask as follows.

$${I}_{d - R - LC - m} = {I}_{d - R} \cdot ( 1 - {M}_{d} ) + {I}_{d - R - LC} \cdot {M}_{d}$$

M_{d}: 30×30 Logo Mask

$${M}_{d} = clip ( ( 1 - TLB ) * {s}_{mask} , 0 , 1 )$$

where M_{d} is generated using the TLB.

The TLB is updated as follows.

$${TLB}_{updated} = clip ( \frac{{I}_{d - R - LC - m}^{2.2}}{{I}_{d}^{2.2}} , TLB * {W}_{low} , TLB * {W}_{high}$$

W_{low} and W_{high} are lower and upper bounds for the updated TLB.

The “unsharp mask” processing is utilized on a full resolution image for detail restoration and sharpening. To reduce the system cost, the disclosed technology converts the RGB image to YCbCr and applies this on Y only and converts YCbCr to RGB again (see FIG. 1). In one or more embodiments, the overall process of detail restoration and sharpening 309 processing (FIG. 3) is as follows. RGB is converted to YCbCr. The luminance reduced Y (Y_{R}) generation is processed by using the upsampled TLB (TLBᵤₚ), which has the same size of the original Y:

$${Y}_{R} = {( {Y}^{2.2} \cdot {TLB}_{up} )}^{\frac{1}{2.2}} .$$

For detail extraction, the detail image (R) is extracted from the original Y (since the detail image is obtained from the original Y, not from the reduced image, the system can keep the details): R=(δ−H_{G})*Y, H_{G}: 3×3 or 3×5 Gaussian filter. For detail enhancement (or sharpening), the system generates the luminance reduced image with sharp edges or restored details (Y_{RS}) by adjusting β₁ and β₂ as follows (for least potential burn-in by this processing, the disclosed technology can set a small value for β₁).

$${Y}_{RS} = {Y}_{R} + {β}_{1} {R}_{+} + {β}_{2} {R}_{-}$$

R₋=R where R<−th
   otherwise 0
R₊=R where R≥th
   otherwise 0.

If it is desired to make the exact same burn-in potential with this processing, the disclosed technology can set β₁=0. In some cases, the disclosed technology can set a small value for β₁>0 because this setting generates a more natural sharpening effect. Then, the system combines Y_{RS} with chrominance and converts them to RGB.

In some embodiments, with the modified luminance reduction processing the effects of local contrast enhancement using 30×30 TLB (utilizing the updated TLB for local contrast enhancement 411 processing) may not be easily visible because a 30×30 TLB may be too small to make a local contrast on a stationary region. TLB interpolation in local luminance reduction can be modified to make local contrast enhancement up to a pixel resolution with the least hardware cost increase. If the TLB size is increased in some embodiments, this processing can be opted out. The processing includes upsampled probability Mask (Mᵤ) generation utilizing the following:

$${M}_{u} = Up ( clip ( ( 1 - {TLB}_{30 \times 30} ) * {s}_{mask} , 0 , 1 ) ) .$$

In some embodiments, for all the up-sampling, bi-linear up-sampling is utilized. The local contrast weight is computed on full resolution as follows:

$$W = clip ( S \cdot \frac{1}{Up ( {I}_{d} )} , {b}_{low} , {b}_{high}$$

b_{low}, b_{high}: lower and upper limits for weight
I_{d}: 30×30 gray image
S: tunable weight strength.
For full resolution TLB generation, the following is utilized:

$${TLB}_{full} = ( W \cdot Up ( {TLB}_{30 \times 30} ) ) \cdot {M}_{u} + Up ( {TLB}_{30 \times 30} ) \cdot ( 1 - {M}_{u} ) .$$

If this option is turned off with a larger TLB, the full resolution TLB is simply generated by upsampling TLB_{30×30}:TLB_{full}=Up(TLB_{30×30}). For a locally contrast enhanced luminance reduced image generation, the following is utilized:

$${I}_{R} = {( {I}^{2.2} \cdot {TLB}_{full} )}^{\frac{1}{2.2}} .$$

In one or more embodiments, the disclosed technology blends the luminance reduced image (I_{R}) and luminance reduced image with detail restoration (I_{RS}). For mask generation, for an upsampling mask, the disclosed technology uses bi-linear upsampling utilizing the following:

$${M}_{u} = Upscale ( clip ( ( 1 - TLB ) * {s}_{mask} , 0 , 1 ) ) .$$

For blend processing, using the luminance reduced Y image (I_{R}), the luminance reduced image with sharp edges or restored details (I_{RS}), and the upsampled mask, the disclosed technology blends the final Y image utilizing the following: I_{Final}=I_{R}·(1−Mᵤ)+I_{RS}·Mᵤ.

Utilizing the aforementioned details, the disclosed technology can provide a balance between image quality and burn-in protection. The disclosed technology can be implemented, for example, in OLED displays for televisions, smart phones, wearable devices, tablets, laptops, automotive displays, virtual reality (VR) displays, augmented reality (AR) displays, headset displays, digital cameras and camcorders, medical device displays, etc.

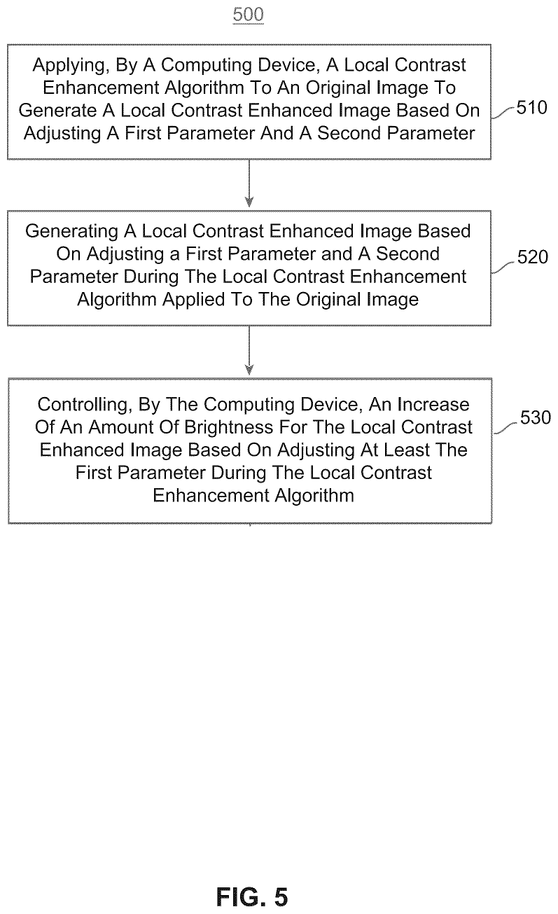

FIG. 5 illustrates a process 500 for providing display imaging perceptual local contrast and detail enhancement, according to some embodiments. In block 510, process 500 applies, by a computing device, a local contrast enhancement algorithm (or process) to an original image. In block 520, process 500 generates a local contrast enhanced image is generated based on adjusting a first parameter (e.g., α₁) and a second parameter (e.g., α₂) (see, e.g., update TLB for local contrast enhancement 411 processing, described above) during the local contrast enhancement algorithm applied to the original image. In block 530, process 500 controls, by the computing device, an increase of an amount of brightness for the local contrast enhanced image based on adjusting at least the first parameter during the local contrast enhancement algorithm.

In some embodiments, process 500 includes the feature that the local contrast enhancement algorithm separately controls a positive detailed image (e.g., R₊) and a negative detailed image (e.g., R₋).

In one or more embodiments, process 500 further includes the feature that the local contrast enhancement algorithm provides a balance between image quality and burn-in protection for OLED displays.

In one or more embodiments, process 500 additionally provides for extracting a detail image from the original image before a luminance reduction process.

In one or more embodiments, process 500 further provides for adding back the extracted detail image to the local contrast enhanced image to control balancing between edge enhancement and burn-in protection.

In one or more embodiments, process 500 additionally provides for utilizing a TLB to control a rate of brightness reduction on a stationary region of the original image and to provide local image contrast enhancement.

In some embodiments, process 500 includes the feature that the TLB is utilized to generate a reduction weight map and a local contrast enhancement gain map.

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the disclosed technology. As used herein, the singular forms “a”, an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the disclosed technology.

Though the embodiments have been described with reference to certain versions thereof; however, other versions are possible. Therefore, the spirit and scope of the appended claims should not be limited to the description of the preferred versions contained herein.

What is claimed is:

1. A computer-implemented method comprising:
applying, by a computing device, a local contrast enhancement algorithm to an original image;
generating a local contrast enhanced image based on adjusting a first parameter and a second parameter during the local contrast enhancement algorithm applied to the original image; and
controlling, by the computing device, an increase of an amount of brightness for the local contrast enhanced image based on adjusting at least the first parameter during the local contrast enhancement algorithm.

2. The method of claim 1, wherein the local contrast enhancement algorithm separately controls a positive detailed image and a negative detailed image.

3. The method of claim 1, wherein the local contrast enhancement algorithm provides a balance between image quality and burn-in protection for organic light emitting diode (OLED) displays.

4. The method of claim 1, further comprising:
extracting a detail image from the original image before a luminance reduction process.

5. The method of claim 4, further comprising:
adding back the extracted detail image to the local contrast enhanced image to control balancing between edge enhancement and burn-in protection.

6. The method of claim 1, further comprising
utilizing a target luminance buffer to control a rate of brightness reduction on a stationary region of the original image and to provide local image contrast enhancement.

7. The method of claim 6, wherein the target luminance buffer is utilized to generate a reduction weight map and a local contrast enhancement gain map.

8. A non-transitory processor-readable medium that includes a program that when executed by a processor provides perceptual local contrast and detail enhancement, comprising:
applying, by the processor, a local contrast enhancement algorithm to an original image;
generating, by the processor, a local contrast enhanced image based on adjusting a first parameter and a second parameter during the local contrast enhancement algorithm applied to the original image; and
controlling, by the processor, an increase of an amount of brightness for the local contrast enhanced image based on adjusting at least the first parameter during the local contrast enhancement algorithm.

9. The non-transitory processor-readable medium of claim 8, wherein the local contrast enhancement algorithm separately controls a positive detailed image and a negative detailed image.

10. The non-transitory processor-readable medium of claim 8, wherein the local contrast enhancement algorithm provides a balance between image quality and burn-in protection for organic light emitting diode (OLED) displays.

11. The non-transitory processor-readable medium of claim 8, further comprising:
extracting a detail image from the original image before a luminance reduction process.

12. The non-transitory processor-readable medium of claim 11, further comprising:
adding back the extracted detail image to the local contrast enhanced image to control balancing between edge enhancement and burn-in protection.

13. The non-transitory processor-readable medium of claim 8, further comprising
utilizing a target luminance buffer to control a rate of brightness reduction on a stationary region of the original image and to provide local image contrast enhancement.

14. The non-transitory processor-readable medium of claim 13, wherein the target luminance buffer is utilized to generate a reduction weight map and a local contrast enhancement gain map.

15. An apparatus comprising:
a memory storing instructions; and
at least one processor executes the instructions including a process configured to:
apply a local contrast enhancement algorithm to an original image;
generate a local contrast enhanced image based on adjusting a first parameter and a second parameter during the local contrast enhancement algorithm applied to the original image; and
control an increase of an amount of brightness for the local contrast enhanced image based on adjusting at least the first parameter during the local contrast enhancement algorithm.

16. The apparatus of claim 15, wherein the local contrast enhancement algorithm separately controls a positive detailed image and a negative detailed image.

17. The apparatus of claim 15, wherein the local contrast enhancement algorithm provides a balance between image quality and burn-in protection for organic light emitting diode (OLED) displays.

18. The apparatus of claim 15, wherein the process is configured to:
extract a detail image from the original image before a luminance reduction process.

19. The apparatus of claim 18, wherein the process is further configured to:
add back the extracted detail image to the local contrast enhanced image to control balancing between edge enhancement and burn-in protection.

20. The apparatus of claim 15, wherein:
the process is further configured to:
utilize a target luminance buffer to control a rate of brightness reduction on a stationary region of the original image and to provide local image contrast enhancement; and
the target luminance buffer is utilized to generate a reduction weight map and a local contrast enhancement gain map.
